(19) United States
(12) Patent Application Publication
(10) Pub. No.: US 2026/0315927 A1
(43) Pub. Date: Oct. 15, 2026

(54) INFORMATION PROCESSING DEVICE, INFORMATION PROCESSING METHOD, AND COMPUTER PROGRAM

(71) Applicant: Sony Interactive Entertainment Inc., Tokyo (JP)

(72) Inventors: Kazuharu Tanaka, Kanagawa (JP); Kiko Sasaki, Chiba (JP); Ryota Murasugi, Chiba (JP)

(73) Assignee: Sony Interactive Entertainment Inc., Tokyo (JP)

(21) Appl. No.: 19/484,924

(22) PCT Filed: May 16, 2023
(86) PCT No.: PCT/JP2023/018239

§ 371 Date: Nov. 17, 2025

(51) Int. Cl. A63F 13/56; A63F 13/65

(52) U.S. Cl. CPC A63F 13/56; A63F 13/65

(57) ABSTRACT

An information processing device includes a non-player character (NPC) placement section configured for placing, at a venue for an event in a virtual space, a NPC as a participant in the event, and a NPC control section configured for controlling the NPC to perform movements that mimic movements of a participant in the event corresponding to a person in a real world. The participant in the event may be one of a performer of the event, an avatar of the performer, an audience member, and an avatar of the audience member. The NPC placement section may place a plurality of NPCs to control a first portion of the NPCs to move in a first pattern while a second portion of the NPCs move in a second pattern different from the first pattern. The first portion may be greater than the second portion.

### TECHNICAL FIELD

The present invention relates to a data processing technology, in particular, to an information processing device, an information processing method, and a computer program.

### BACKGROUND ART

A metaverse which is a three-dimensional virtual space service provided by computers is expected to become more widespread in the future. For example, users operate their own avatars in the metaverse to interact with other users or participate in events (e.g., concerts) held in the metaverse.

### SUMMARY

### Technical Problem

For the success of an event in the metaverse, it is important to gather many people for the event. For example, in an event where many avatars are gathered, a lively atmosphere may be developed, which in turn attracts more people, leading to the success of the event. However, under a situation where an increase in the number of metaverses and an increase in the number of events held in the metaverses are expected, it is conceivable that some events cannot attract a sufficient number of people. It is an object of the present invention to provide a technology for supporting the development of a lively atmosphere at an event in a virtual space.

### Solution to Problem

To solve the above-mentioned problem, an information processing device according to an aspect of the present invention includes a non-player character (NPC) placement section configured to place, at a venue for an event in a virtual space, an NPC as a participant in the event and an NPC control section configured to control the NPC so as to perform movements that mimic movements of a participant in the event who corresponds to a person in a real world.

Another aspect of the present invention is directed to an information processing method. This method includes, by a computer, a step of placing, at a venue for an event in a virtual space, an NPC as a participant in the event and a step of controlling the NPC so as to perform movements that mimic movements of a participant in the event who corresponds to a person in a real world.

Note that any combination of the above components and conversions of the expressions of the present invention between systems, computer programs, recording media having stored therein computer programs, and the like are also effective as aspects of the present invention.

### Advantageous Effects of Invention

According to the present invention, it is possible to support the development of a lively atmosphere at the event in the virtual space.

### BRIEF DESCRIPTION OF DRAWINGS

FIG. 1 is a diagram illustrating the configuration of a metaverse system according to an embodiment.

FIG. 2 is a block diagram illustrating the main functional blocks of a user device.

FIG. 3 is a block diagram illustrating the main functional blocks of a metaverse server.

FIG. 4 is a flowchart illustrating the operation of the metaverse system according to the embodiment.

FIG. 5 is a diagram illustrating a first example of a metaverse image.

FIG. 6 is a diagram illustrating a second example of the metaverse image.

### DESCRIPTION OF EMBODIMENT

The outline of an embodiment will be described. For the success of an event in a metaverse, it is important to gather many people for the event. However, under a situation where an increase in the number of metaverses and an increase in the number of events held in the metaverses are expected, it is conceivable that some events cannot attract a sufficient number of people. Therefore, according to the embodiment, there is proposed a technology for supporting the development of a lively atmosphere at an event in a metaverse.

Specifically, in a metaverse system according to the embodiment, a non-player character (hereinafter referred to as an “NPC”) is placed at a venue for an event in a metaverse. An NPC is a character that is not operated by a user but is operated automatically by the system. In the metaverse system according to the embodiment, the NPC placed at the venue for the event is caused to perform movements that mimic the movements of a performer or an audience member of the event (for example, a user of the metaverse).

In the embodiment, the event held in the metaverse is assumed to be a concert as a music event. However, the technical ideas described in the embodiment can be applied not only to concerts but also to various events in the metaverse, thereby supporting the development of a lively atmosphere and the attraction of people. Note that, unless otherwise specified, the values of various thresholds in the following embodiment and modifications may be determined appropriately according to the knowledge of developers or experiments using the metaverse system.

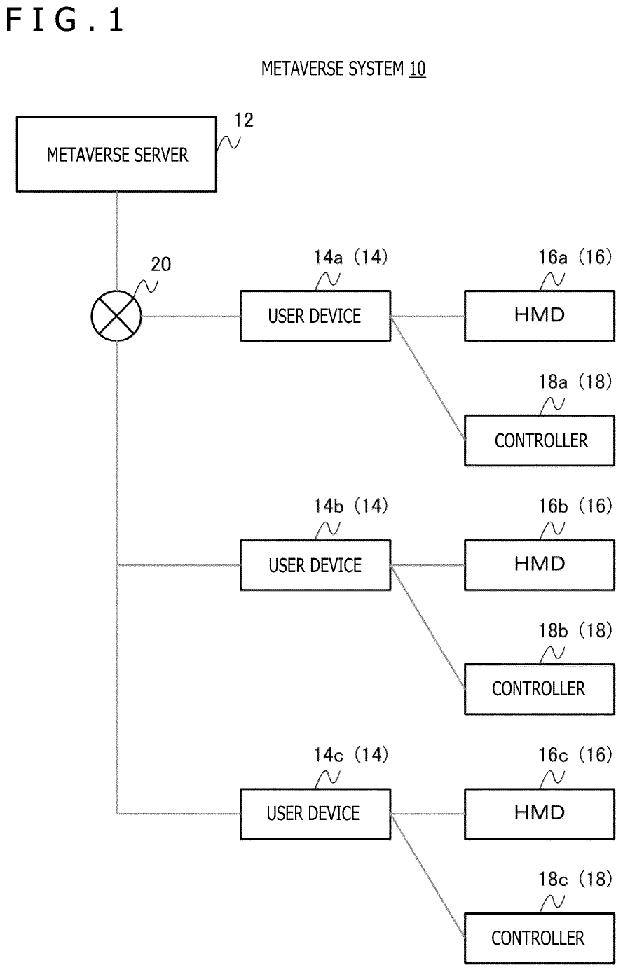

FIG. 1 illustrates the configuration of a metaverse system 10 according to the embodiment. The metaverse system 10 is an information processing system configured to provide a metaverse service to a plurality of users. The metaverse system 10 includes a metaverse server 12 and a plurality of user systems.

The metaverse server 12 is an information processing device configured to execute processing related to the management of the metaverse. Among the plurality of user systems, a system for a user A includes a user device 14a, an HMD (Head-Mounted Display) 16a, and a controller 18a. A system for a user B includes a user device 14b, an HMD 16b, and a controller 18b. A system for a user C includes a user device 14c, an HMD 16c, and a controller 18c.

The user device 14a, the user device 14b, and the user device 14c (referred to as “user devices 14” when they are referred to collectively) are information processing devices that are operated by users who uses the metaverse. The users in the embodiment are participants in the event in the metaverse and include, for example, performers and audience members of the event. The user device 14 may be a PC (Personal Computer), a smartphone, a tablet terminal, or a game console. The user device 14 communicates with the metaverse server 12 via a communication network 20 including a LAN (Local Area Network), a WAN (Wide Area Network), or the Internet.

The HMD 16a, the HMD 16b, and the HMD 16c (referred to as “HMDs 16” when they are referred to collectively) are HMDs that are mounted on the heads of the users. In the embodiment, it is assumed that a display device of the user is the HMD 16 and that an image of the metaverse is displayed on the HMD 16. As a modification, the image of the metaverse may be displayed on a television or a computer display. The HMD 16 is connected to the user device 14 via a wired or wireless connection.

The controller 18a, the controller 18b, and the controller 18c (referred to as “controllers 18” when they are referred to collectively) are operation devices configured to receive operations input by the users. The controller 18 may include a plurality of buttons and analog sticks. The controller 18 is connected to the user device 14 via a wired or wireless connection. The function of the user device 14, the function of the HMD 16 (display function), and the function of the controller 18 may be consolidated into a single information processing device.

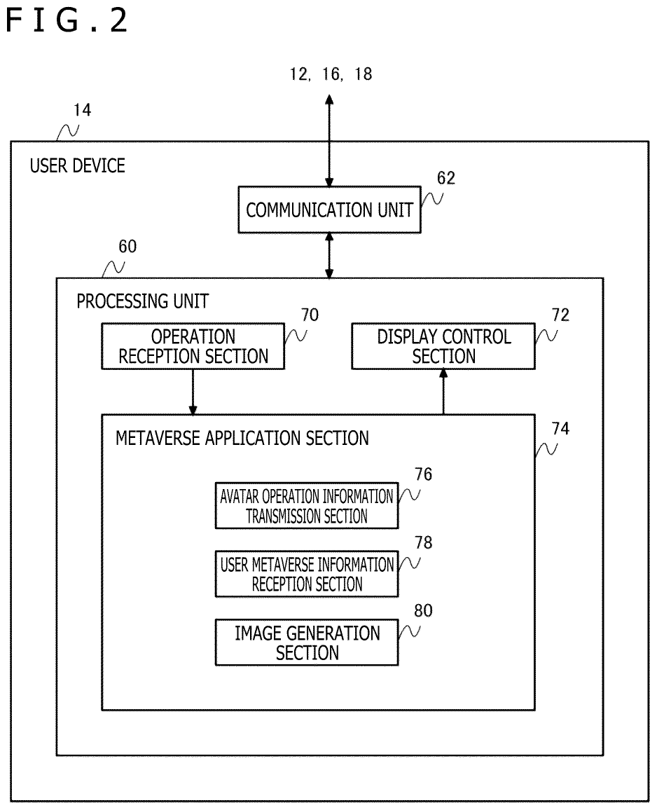

FIG. 2 is a block diagram illustrating the main functional blocks of the user device 14. The respective blocks illustrated in the block diagrams of the present specification can be achieved in hardware by elements including a processor, CPU (Central Processing Unit), and memory of a computer or by electronic circuits or mechanical devices, and can be achieved in software by computer programs loaded into memories, or the like. The functional blocks illustrated herein are achieved by the cooperation of hardware and software. Thus, it is to be understood by those skilled in the art that these functional blocks can be achieved in various forms by a combination of hardware and software.

The user device 14 includes a processing unit 60 and a communication unit 62. The processing unit 60 executes data processing and controls the operation of the user device 14. The communication unit 62 communicates with external devices in accordance with a predetermined communication protocol. The processing unit 60 transmits and receives data to and from the metaverse server 12, the HMD 16, and the controller 18 through the communication unit 62.

The processing unit 60 includes an operation reception section 70, a display control section 72, and a metaverse application section 74. The functions of a plurality of functional blocks included in the processing unit 60 may be implemented by computer programs (for example, system software or application software). These computer programs may be stored in a recording medium and installed in the storage of the user device 14 through the recording medium. Alternatively, these computer programs may be downloaded via a network and installed in the storage of the user device 14. The processor of the user device 14 may perform the functions of the above-mentioned plurality of functional blocks by reading these computer programs into the main memory and executing the computer programs.

The operation reception section 70 receives information that is transmitted from the controller 18 and associated with an operation input to the controller 18. The display control section 72 controls contents to be displayed on the HMD 16. In the embodiment, the display control section 72 transmits, to the HMD 16, data of an image that is generated by an image generation section 80 to be described later and that indicates the state of the metaverse (a metaverse image to be described later), and causes the HMD 16 to display the image of the metaverse.

The metaverse application section 74 executes user-side processing related to the display of the metaverse. The metaverse application section 74 includes an avatar operation information transmission section 76, a user metaverse information reception section 78, and the image generation section 80.

The avatar operation information transmission section 76 transmits, to the metaverse server 12, avatar operation information which is information associated with an operation performed by the user for an avatar placed in the metaverse, that is, information associated with the movements of the avatar. The avatar operation information in the embodiment includes skeletal information (also referred to as bone data) that indicates the movements of the skeleton of the avatar. As a modification, the avatar operation information may include information indicating the type of button pressed on the controller 18 or information indicating the direction and amount in and by which the analog stick of the controller 18 has been tilted.

The user metaverse information reception section 78 receives user metaverse information transmitted from the metaverse server 12. The user metaverse information is information associated with a metaverse currently used by the user, that is, information associated with a virtual space in which the avatar of the user is placed. The user metaverse information includes information necessary to generate a metaverse image to be displayed on the HMD 16.

The image generation section 80 generates a metaverse image to be presented to the user, on the basis of the user metaverse information received by the user metaverse information reception section 78. The metaverse image is an image of the metaverse currently used by the user, as seen from the viewpoint of the user, that is, an image of the virtual space that the avatar of the user has entered. The metaverse image in the embodiment is a video indicating the state of a virtual concert (virtual live performance) in which avatars of performers are placed on the stage while avatars of audience members are placed in audience seats.

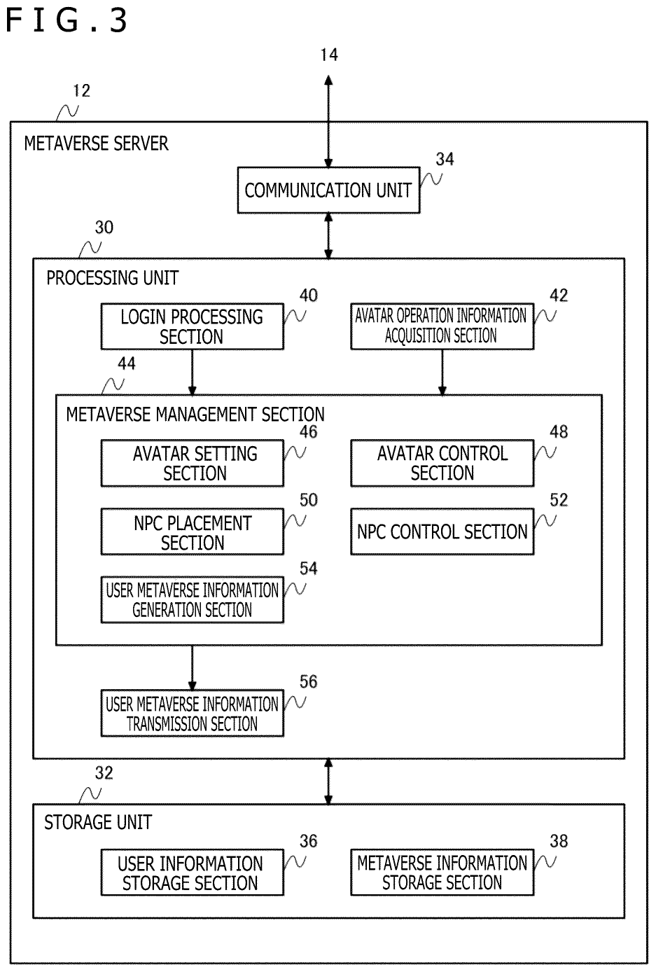

FIG. 3 is a block diagram illustrating the main functional blocks of the metaverse server 12. The metaverse server 12 includes a processing unit 30, a storage unit 32, and a communication unit 34. The processing unit 30 executes information processing for metaverse management. The storage unit 32 stores data to be referenced or updated by the processing unit 30. The communication unit 34 communicates with external devices in accordance with a predetermined communication protocol. The processing unit 30 transmits and receives data to and from the user device 14 through the communication unit 34.

The storage unit 32 includes a user information storage section 36 and a metaverse information storage section 38. The user information storage section 36 stores user information that is information associated with users who use the metaverse managed by the metaverse server 12. The user information includes (1) user identification information and (2) information associated with the avatars of the users (e.g., appearance data).

The metaverse information storage section 38 stores metaverse information that is information associated with a metaverse currently used by a plurality of users. The metaverse information includes (1) metaverse identification information, (2) information associated with objects placed in the metaverse (e.g., position and appearance data), (3) identification information regarding users who have entered the metaverse, and (4) the placement positions of avatars of the respective users in the metaverse.

The processing unit 30 includes a login processing section 40, an avatar operation information acquisition section 42, a metaverse management section 44, and a user metaverse information transmission section 56. The functions of a plurality of functional blocks included in the processing unit 30 may be implemented by computer programs (for example, system software or application software). These computer programs may be stored in a recording medium and installed in the storage of the metaverse server 12 through the recording medium. Alternatively, these computer programs may be downloaded via a network and installed in the storage of the metaverse server 12. The processor of the metaverse server 12 may perform the functions of the above-mentioned plurality of functional blocks by reading these computer programs into the main memory and executing the computer programs.

The login processing section 40 receives a request to log in to the metaverse which is transmitted from the user device 14, and executes login processing (e.g., authentication processing). In the case of successfully authenticating the user, the login processing section 40 determines to allow the user to enter the metaverse specified by the user and updates the metaverse information in the metaverse information storage section 38.

The avatar operation information acquisition section 42 receives avatar operation information transmitted from the user device 14. The avatar operation information acquisition section 42 inputs the avatar operation information to the metaverse management section 44.

The metaverse management section 44 executes processing related to each metaverse, on the basis of a plurality of pieces of metaverse information stored in the metaverse information storage section 38. The metaverse management section 44 includes an avatar setting section 46, an avatar control section 48, an NPC placement section 50, an NPC control section 52, and a user metaverse information generation section 54.

The avatar setting section 46 places, in the metaverse, a plurality of avatars corresponding to a plurality of users. The avatar setting section 46 records the placement position of the avatar of each user in the metaverse in the metaverse information in the metaverse information storage section 38.

The avatar control section 48 controls the movements of the avatar of each user in the metaverse on the basis of the skeletal information of the avatar which is included in the avatar operation information received by the avatar operation information acquisition section 42.

The NPC placement section 50 places NPCs as event participants at a venue for an event in the metaverse. In the embodiment, the NPC placement section 50 places NPCs as audience members in audience seats of a venue for a virtual concert. The NPCs may have appearances and shapes similar to those of the avatars of the users (also called player characters).

The NPC control section 52 controls the NPCs so as to perform movements that mimic the movements of event participants corresponding to persons in a real world. In the embodiment, the event participants corresponding to persons in the real world include the avatars of the performers of the concert and the avatars of the audience members of the concert. In the embodiment, when the avatars of the event participants corresponding to persons in the real world perform movements, the NPC control section 52 causes the NPCs to perform the same movements.

The user metaverse information generation section 54 generates user metaverse information that is information associated with the display of a metaverse for each user, on the basis of (1) metaverse information associated with the metaverse that the corresponding user has entered, (2) avatar information of the corresponding user and other users (appearances, positions, and movements), and (3) the placement positions and movements of the NPCs. For example, as the user metaverse information to be provided to the user device 14a of the user A described above, the user metaverse information generation section 54 generates the user metaverse information including information regarding the positions, appearances, and movements of various objects (including avatars and NPCs) in the metaverse which are viewed from the viewpoint position of the user A.

The user metaverse information transmission section 56 transmits the user metaverse information generated for each user by the user metaverse information generation section 54, to the user devices 14 of the corresponding user.

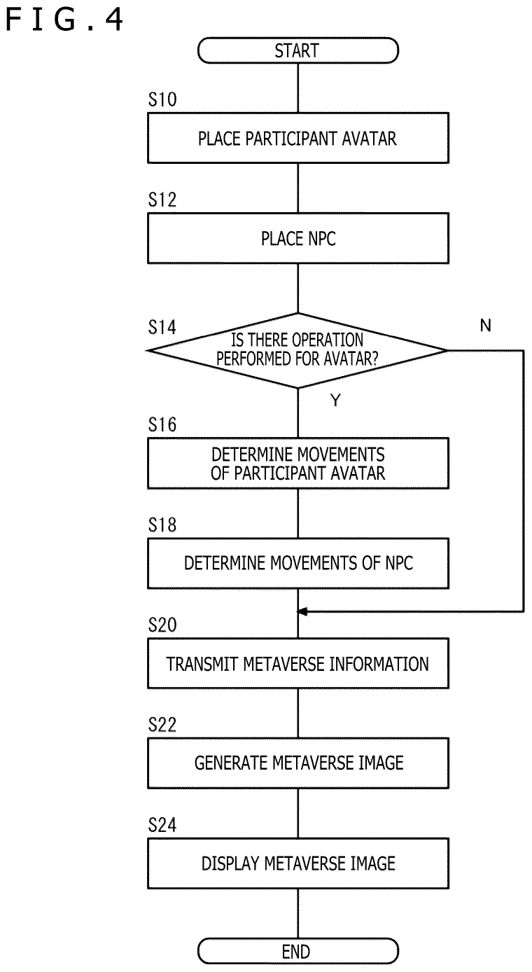

FIG. 4 is a flowchart illustrating the operation of the metaverse system 10 according to the embodiment. The operation of the metaverse system 10 is described below with reference to FIG. 4.

On the basis of an operation performed by a user, the user device 14 transmits a request to log in to a metaverse to the metaverse server 12. The login processing section 40 of the metaverse server 12 receives the request to log in to the metaverse, which is transmitted from the user device 14. When the login request is received, the avatar setting section 46 of the metaverse server 12 places, in the metaverse, an avatar registered by the user in advance and stored in the user information storage section 36 (S10).

In the embodiment, the avatar setting section 46 places, on a stage of a venue for an event, avatars of users who participate in the event as performers (hereinafter also referred to as “performer avatars”). In addition, the avatar setting section 46 places, in audience seats of the event venue, avatars of users who participate in the event as audience members (hereinafter also referred to as “audience avatars”).

Further, the NPC placement section 50 places, in the audience seats of the event venue, NPCs with appearances that imitate the audience members of the event (S12). That is, in the metaverse of the embodiment, both the avatars corresponding to real persons (audience avatars) and the NPCs are placed in the audience seats of the event venue. Hereinafter, in a case where the performer avatars and the audience avatars are collectively referred to, they are also referred to as “participant avatars.”

The avatar operation information acquisition section 42 of the metaverse server 12 receives avatar operation information associated with the participant avatars and transmitted from the user devices 14. In a case where the avatar operation information is received (Y in S14), the avatar control section 48 of the metaverse server 12 determines the movements of the participant avatars in the metaverse on the basis of the skeletal information of the participant avatars which is included in the avatar operation information (S16). The avatar control section 48 may use a known technology to reflect the movements of the skeletons indicated by the skeletal information of the participant avatars, in the movements of the participant avatars in the metaverse. The movements of the participant avatars may include, for example, raising a hand, clapping, jumping, or swaying the body.

The NPC control section 52 of the metaverse server 12 determines the movements of the NPCs such that the NPCs mimic the movements of the participant avatars (S18). For example, the NPC control section 52 may detect the movements of the participant avatars by cooperating with the avatar control section 48 and set the same movements as the participant avatars as the movements of the NPCs. When no operation is input to any participant avatar (N in S14), the processing of S16 and S18 is omitted.

The user metaverse information generation section 54 of the metaverse server 12 generates user metaverse information which includes information regarding the positions and movements of the participant avatars and information regarding the positions and movements of the NPCs and which indicates the states of the metaverse as seen from the viewpoint positions of the users. The user metaverse information transmission section 56 of the metaverse server 12 transmits the user metaverse information to each of the user devices 14 (S20).

The image generation section 80 of the user device 14 generates a metaverse image which is an image (including a video) of the metaverse, on the basis of the user metaverse information transmitted from the metaverse server 12 (S22). The display control section 72 of the user device 14 causes the HMD 16 connected thereto to display the metaverse image (S24).

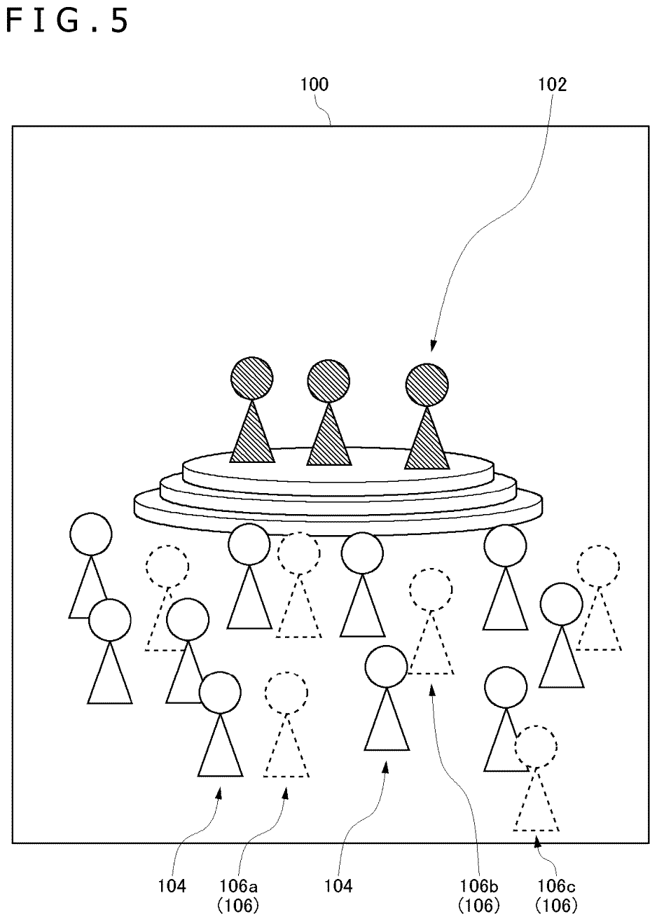

FIG. 5 illustrates a first example of the metaverse image. A metaverse image 100 indicates the state of a venue for a concert held in the metaverse. The metaverse image 100 is provided to users who are audience members of the concert. The avatar setting section 46 of the metaverse server 12 places, on the stage of the concert venue, a plurality of performer avatars 102 (indicated with shading added) that correspond to a plurality of performers and places, in the audience seats below the stage, a plurality of audience avatars 104 (indicated with solid line frames) that correspond to a plurality of audience members. Further, the NPC placement section 50 of the metaverse server 12 places, in the audience seats below the stage, a plurality of NPCs 106 (indicated with dashed line frames) that imitate the audience members.

The NPC control section 52 of the metaverse server 12 controls some of the plurality of NPCs 106 so as to move in a first pattern. Further, the NPC control section 52 controls some other of the plurality of NPCs 106 so as to move in a second pattern different from the first pattern.

The plurality of NPCs 106 in FIG. 5 includes NPCs 106a, NPCs 106b, and NPCs 106c. The NPC control section 52 controls the NPCs 106a so as to perform movements that mimic the movements of the performer avatars 102. For example, the NPC control section 52 may acquire information associated with the movements of the performer avatars 102 from the avatar control section 48 and control the NPCs 106a so as to perform the same movements as the performer avatars 102.

Further, the NPC control section 52 controls the NPCs 106b so as to perform movements that mimic the movements of the audience avatars 104. For example, the NPC control section 52 may acquire information associated with the movements of the audience avatars 104 from the avatar control section 48 and control the NPCs 106b so as to perform the same movements as the audience avatars 104.

Further, the NPC control section 52 controls the NPCs 106c so as to perform movements suitable for the music (musical piece) being reproduced at the concert. For example, the metaverse management section 44 may include a music analysis section (not illustrated) configured to analyze the rhythm, melody, chord, and genre of the music. The NPC control section 52 may determine the movements of the NPCs 106c on the basis of the result of the analysis by the music analysis section. For example, the NPC control section 52 may cause the bodies of the NPCs 106c to sway up and down when the music is in a rock style. The NPC control section 52 may cause the bodies of the NPCs 106c to sway from side to side when the music is in a funk style. When the music is a song from a pop star, the NPC control section 52 may cause the NPCs 106c to perform choreographed movements associated with the relevant song in advance.

The NPC control section 52 makes the proportion of the NPCs 106 that move in such a pattern as to mimic the movements of the performer avatars 102 among the plurality of NPCs 106 greater than the proportion of the NPCs 106 that move in another pattern. For example, the NPC control section 52 may place, at the concert venue in the metaverse, the NPCs 106a that mimic the movements of the performer avatars 102, the NPCs 106b that mimic the movements of the audience avatars 104, and the NPCs 106c that move along with the music, at a ratio of 2:1:1.

The NPC control section 52 controls one NPC 106b so as to perform movements that mimic the movements of the audience avatar 104 that is present within a predetermined range of distance from the one NPC 106b. This range may be defined in advance by using the coordinate values in the metaverse. For example, when placing the NPC 106b, the NPC placement section 50 may record the audience avatar 104 that is present within the predetermined range of distance from the NPC 106b, in the metaverse information in the metaverse information storage section 38 in association with the relevant NPC 106b. The NPC control section 52 may set, as the movements of one NPC 106b, the same movements as the audience avatar 104 associated with the one NPC 106b in the metaverse information.

The NPC placement section 50 places the plurality of NPCs 106 such that the density of the NPCs 106 becomes higher at a position closer to the performer avatars 102 at the concert venue. For example, a first range, a second range, and a third range may be defined in order of proximity to the performer avatars 102. The first range may be less than a first distance from the position of the performer avatars 102. The second range may be equal to or greater than the first distance but less than a second distance from the position of the performer avatars 102 (provided that first distance<second distance). The third range may be equal to or greater than the second distance from the position of the performer avatars 102.

In this case, the NPC placement section 50 may place a single NPC 106 per one square meter (in the area within the metaverse) in the first range. The NPC placement section 50 may place a single NPC 106 per two square meters in the second range. The NPC placement section 50 may place a single NPC 106 per four square meters in the third range. With this, it is possible to achieve the placement of audience members close to that of a real concert and effectively express the liveliness of the concert.

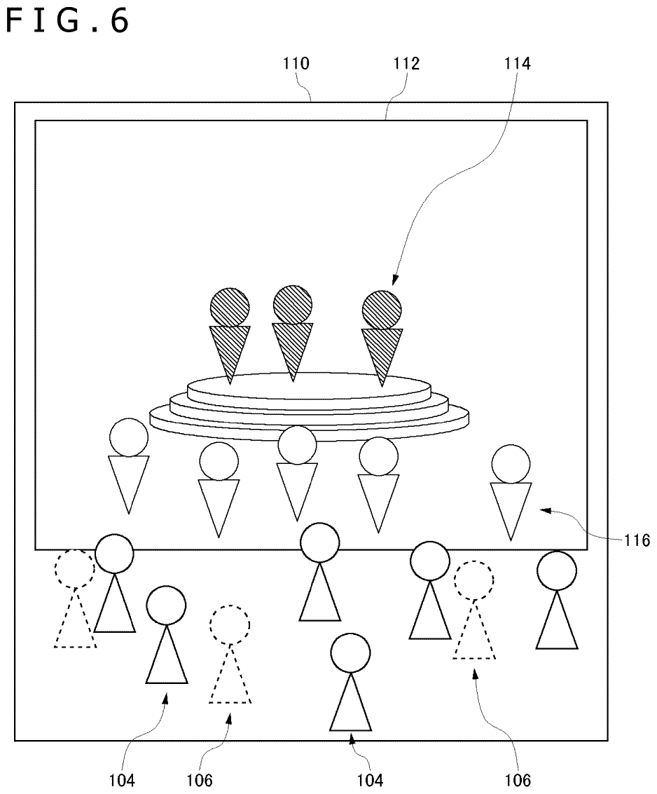

FIG. 6 illustrates a second example of the metaverse image. A metaverse image 110 includes an event image 112 indicating the state of a concert held in the real world. The event image 112 is a video taken at a concert venue in the real world and is a video that captures performers 114 and audience members 116 in the real world. In a concert venue in the metaverse, the event image 112 is reproduced. The event image 112 may be a live video or a recorded video. The avatar setting section 46 places the audience avatars 104 of the users who are viewing the event image 112, at the concert venue in the metaverse.

The NPC placement section 50 places a plurality of NPCs 106 which imitate the audience members who are viewing the event image 112, at the concert venue in the metaverse. The plurality of NPCs 106 include first NPCs 106, second NPCs 106, third NPCs 106, and fourth NPCs 106, which have different movement patterns.

The NPC control section 52 controls the first NPCs 106 so as to perform movements that mimic the movements of the performers 114 appearing in the event image 112. For example, the metaverse management section 44 may further include a performer estimation section (not illustrated) that uses a known technology to identify the performers (for example, persons on the stage) appearing in the event image 112 and to estimate the movements of the performers. The NPC control section 52 may control the first NPCs 106 so as to perform the same movements as the movements of the performers estimated by the performer estimation section.

The NPC control section 52 controls the second NPCs 106 so as to perform movements that mimic the movements of the audience members 116 appearing in the event image 112. For example, the metaverse management section 44 may further include an audience estimation section (not illustrated) that uses a known technology to identify the audience members (for example, persons in the audience seat below the stage) appearing in the event image 112 and to estimate the movements of the audience members. The NPC control section 52 may control the second NPCs 106 so as to perform the same movements as the movements of the audience member estimated by the audience estimation section.

The NPC control section 52 controls the third NPCs 106 so as to perform movements that mimic the movements of the audience avatars 104 placed at the concert venue. For example, the NPC control section 52 may acquire information associated with the movements of the audience avatars 104 from the avatar control section 48 and control the third NPCs 106 so as to perform the same movements as the audience avatars 104.

The NPC control section 52 controls the fourth NPCs 106 so as to perform movements suitable for the music (musical piece) being reproduced at the concert. As illustrated in FIG. 5, objects whose movements are to be imitated by the NPCs 106 may be the avatars of the performers or the avatars of the audience members, which are placed in the metaverse. Further, as illustrated in FIG. 6, objects whose movements are to be imitated by the NPCs 106 may be the performers or audience members in the real world who appear in the video.

With the metaverse system 10 according to the embodiment, the NPCs, which are participants in the event in the virtual space, can be caused to perform movements suitable for that event. With this, a lively atmosphere can be created for the event by using the NPCs. Further, users participating in the same event are less likely to feel a sense of discomfort with the NPCs, thereby enabling a suppression of a decrease in a sense of immersion in the event in the virtual space.

The present invention has been described above on the basis of the embodiment. This embodiment is an example, and it is to be understood by those skilled in the art that various modifications can be made to the combinations of the respective components and processing processes and that such modifications are also within the scope of the present invention.

A first modification is described. The NPC control section 52 of the metaverse server 12 may control the NPCs placed in the metaverse so as to mimic, among the movements of a plurality of event participants corresponding to persons in the real world (for example, the performers or their avatars, or the audience members or their avatars), movements performed by the largest number of the participants.

As described in the embodiment, the NPC control section 52 may control the NPC so as to perform movements that mimic the movements of the audience avatar that is present within the predetermined range of distance from the NPC. In a case where a plurality of audience avatars are present within the predetermined range of distance from the NPC, the NPC control section 52 may classify the respective movements of the plurality of audience avatars into some of a plurality of movement patterns defined in advance. The plurality of movement patterns may include raising a hand, swaying up and down, swaying from side to side, clapping, and the like. The NPC control section 52 may derive the number of movements classified in each movement pattern, on the basis of the result of the classification of the movements of the plurality of audience avatars described above. The NPC control section 52 may set, as the movements of the NPC, the movement pattern in which the largest number of movements are classified.

A second modification is described. As described in the embodiment, the NPC placement section 50 may place the NPCs that move along with the music, in the metaverse image. In this case, the NPC control section 52 may determine and change the movements of each NPC depending on the tempo of the music (the speed of the musical piece). With this, the NPCs can be caused to move in a manner suitable for the music being reproduced in the metaverse.

Specifically, the metaverse management section 44 of the metaverse server 12 may further include a sound analysis section (not illustrated). The sound analysis section may analyze the music (sound) of the concert in the metaverse and acquire the tempo (BPM (Beats Per Minute)) of that music (sound). When the BPM of the music is less than a predetermined threshold, the NPC control section 52 may set the movement of swaying the body from side to side as the movements of the NPCs. When the BPM of the music is equal to or greater than the above-mentioned threshold, the NPC control section 52 may set the movement of swaying the body up and down as the movements of the NPCs. When the sound volume is equal to or greater than a predetermined threshold, the NPC control section 52 may set the movement involving grand gestures (e.g., raising a hand) as the movements of the NPCs.

A third modification is described. Here, an avatar whose movements are to be imitated by the NPCs is referred to as an imitation target avatar. As partially described in the embodiment, the NPC control section 52 may determine the movements of the NPCs such that the NPCs perform the same movements as the imitation target avatar, on the basis of the skeletal information of the imitation target avatar, which is transmitted from the user device 14. Further, the NPC control section 52 may determine the movements of the NPCs on the basis of an operation for the imitation target avatar, which is input to the controller 18 and transmitted from the user device 14 (e.g., information regarding pressed buttons or information regarding stick operations). Moreover, in a case where an image in which the imitation target avatar appears is transmitted and received, the NPC control section 52 may detect the movements of the imitation target avatar by analyzing the image according to a known method and set the movements of the imitation target avatar as the movements of the NPCs.

A fourth modification is described. The functions included in the user device 14 in the above-mentioned embodiment may be included in the metaverse server 12. In this case, the metaverse server 12 may generate the metaverse image and provide the metaverse image to the user device 14. The user device 14 only needs to execute processing for causing the HMD 16 to display data of the metaverse image provided from the metaverse server 12. Further, the functions included in the metaverse server 12 in the above-mentioned embodiment may be included in the user device 14. In this case, a plurality of user devices 14 may communicate and cooperate with each other to perform processing that should be executed synchronously among a plurality of users, such as processing of placing the avatars of a plurality of event participants in the metaverse.

Any combination of the embodiment and modifications described above is also effective as an embodiment of the present invention. An embodiment newly obtained by the combination has the respective effects of the combined embodiment and modifications. Further, it is also to be understood by those skilled in the art that the function to be fulfilled by each constituent feature described in the claims is implemented solely by each of components described in the embodiment and the modifications or implemented through the cooperation of those components. In a case where such a term as “first,” “second,” or the like is used in the present specification or the claims, unless otherwise stated, the term does not indicate any order or importance and is used to distinguish a certain configuration from other configurations.

The technical ideas described in the embodiment and modifications described above can be expressed as the following respective technologies.

### Technology 1

An information processing device including:
an NPC placement section configured to place, at a venue for an event in a virtual space, an NPC as a participant in the event; and
an NPC control section configured to control the NPC so as to perform movements that mimic movements of a participant in the event who corresponds to a person in a real world.

With this information processing device, it becomes possible to cause the NPC, which is the participant in the event in the virtual space, to perform movements suitable for that event.

With this, a lively atmosphere can be created for the event by using the NPC. Further, users participating in the same event are less likely to feel a sense of discomfort with the NPC, thereby enabling a suppression of a decrease in a sense of immersion in the event in the virtual space.

### Technology 2

The information processing device according to Technology 1, in which
the participant in the event who corresponds to the person in the real world is a performer of the event or an avatar of the performer.

With this information processing device, it becomes possible to cause the NPC, which is the participant in the event in the virtual space, to perform movements suitable for that event.

### Technology 3

The information processing device according to Technology 1 or 2, in which
the participant in the event who corresponds to the person in the real world is an audience member of the event or an avatar of the audience member.

It becomes possible to cause the NPC, which is the participant in the event in the virtual space, to perform movements suitable for that event.

### Technology 4

The information processing device according to Technology 3, in which
the NPC control section controls the NPC so as to perform movements that mimic movements of the avatar of the audience member that is present within a predetermined threshold of distance from the NPC in the virtual space.

With this information processing device, it becomes possible to cause the NPC, which is the participant in the event in the virtual space, to perform movements suitable for that event and the NPC position.

### Technology 5

The information processing device according to any one of Technologies 1 to 4, in which
the NPC placement section places a plurality of the NPCs at the venue for the event in the virtual space, and
the NPC control section controls some of the plurality of NPCs so as to move in a first pattern and controls some other of the plurality of NPCs so as to move in a second pattern different from the first pattern.

With this information processing device, the movement patterns of the plurality of NPCs are diversified, so that the users participating in the same event are less likely to feel a sense of discomfort with the NPCs.

### Technology 6

The information processing device according to Technology 5, in which
the NPC control section makes a proportion of the NPCs that move in such a pattern as to mimic movements of a performer of the event or an avatar of the performer among the plurality of NPCs greater than a proportion of the NPCs that move in another pattern.

With this information processing device, a sense of unity between the performer and the audience member in the event can be created.

### Technology 7

The information processing device according to any one of Technologies 1 to 6, in which
the NPC placement section places a plurality of the NPCs at the venue for the event in the virtual space, and
the NPC placement section places the plurality of NPCs such that a density of the NPCs becomes higher at a position closer to a performer of the event or an avatar of the performer.

With this information processing device, the NPCs are placed in the same manner as a real event, so that the users participating in the same event are less likely to feel a sense of discomfort.

### Technology 8

The information processing device according to Technology 1, in which
the NPC control section controls the NPC so as to mimic, among movements of a plurality of participants who correspond to persons in the real world, movements performed by a largest number of the participants.

With this information processing device, it becomes possible to cause the NPC to perform movements suitable for the event.

### Technology 9

### An information processing method including:

by a computer,
a step of placing, at a venue for an event in a virtual space, an NPC as a participant in the event; and
a step of controlling the NPC so as to perform movements that mimic movements of a participant in the event who corresponds to a person in a real world.

With this information processing method, it becomes possible to cause the NPC, which is the participant in the event in the virtual space, to perform movements suitable for that event.

With this, a lively atmosphere can be created for the event by using the NPC. Further, users participating in the same event are less likely to feel a sense of discomfort with the NPC, thereby enabling a suppression of a decrease in a sense of immersion in the event in the virtual space.

### Technology 10

A computer program for causing a computer to implement:
a function of placing, at a venue for an event in a virtual space, an NPC as a participant in the event; and
a function of controlling the NPC so as to perform movements that mimic movements of a participant in the event who corresponds to a person in a real world.

With this computer program, it becomes possible to cause the NPC, which is the participant in the event in the virtual space, to perform movements suitable for that event. With this, a lively atmosphere can be created for the event by using the NPC. Further, users participating in the same event are less likely to feel a sense of discomfort with the NPC, thereby enabling a suppression of a decrease in a sense of immersion in the event in the virtual space.

### Industrial Applicability

The technology according to the present disclosure can be applied to information processing systems, information processing devices, and the like.

### REFERENCE SIGNS LIST

10: Metaverse system
12: Metaverse server
14: User device
36: User information storage section
38: Metaverse information storage section
46: Avatar setting section
48: Avatar control section
50: NPC placement section
52: NPC control section
72: Display control section
80: Image generation section

1. An information processing device comprising:
a non-player character placement section configured for placing, at a venue for an event in a virtual space, a non-player character as a participant in the event; and
a non-player character control section configured for controlling the non-player character to perform movements that mimic movements of a participant in the event corresponding to a person in a real world.

2. The information processing device of claim 1, wherein
the participant in the event corresponding to the person in the real world is at least one of a performer of the event and an avatar of the performer.

3. The information processing device of claim 1, wherein
the participant in the event corresponding to the person in the real world is at least one of an audience member of the event and an avatar of the audience member.

4. The information processing device of claim 3, wherein
the non-player character control section controls the non-player character to perform movements that mimic movements of the avatar of the audience member, the avatar of the audience member being present within a predetermined threshold of distance from the non-player character in the virtual space.

5. The information processing device of claim 1, wherein
the non-player character placement section places a plurality of non-player characters at the venue for the event in the virtual space, and
the non-player character control section controls a first portion of the plurality of non-player characters to move in a first pattern and controls a second portion of the plurality of non-player characters to move in a second pattern different from the first pattern.

6. The information processing device of claim 5, wherein
the first pattern mimics movements of at least one of a performer of the event and an avatar of the performer, and
the first portion is greater than the second portion.

7. The information processing device of claim 1, wherein
the non-player character placement section places a plurality of non-player characters at the venue for the event in the virtual space, and
the non-player character placement section places the plurality of non-player characters such that a density of the non-player characters according to proximity in the virtual space to at least one of a performer of the event and an avatar of the performer.

8. The information processing device of claim 1, wherein
the non-player character control section controls the non-player character to mimic, among movements of a plurality of participants corresponding to persons in the real world, movements performed by a largest number of the participants.

9. An information processing method comprising:
by a computer,
placing, at a venue for an event in a virtual space, a non-player character as a participant in the event; and
controlling the non-player character to perform movements that mimic movements of a participant in the event corresponding to a person in a real world.

10. A non-transitory computer readable medium comprising processor-executable instructions that, when executed by one or more processors of a computer, cause the computer to at least:
by a non-player character placement section, place, at a venue for an event in a virtual space, a non-player character as a participant in the event; and
by a non-player character placement section, control the non-player character so as to perform movements that mimic movements of a participant in the event corresponding to a person in a real world.
